(19) United States
(12) Patent Application Publication
(10) Pub. No.: US 2012/0119508 A1
(43) Pub. Date: May 17, 2012

(54) Gravity and Buoyancy Electricity Generation System

(76) Inventor: Ushijima Shiro Cresto Sparks, Tokyo (JP)

(21) Appl. No.: 13/104,042

(22) Filed: May 10, 2011

(30) Foreign Application Priority Data
Nov. 12, 2010 (JP) 510316095

(51) Int. Cl. H02K 7/18; F03B 17/04

(52) U.S. Cl. 290/1 A; 74/DIG. 9

(57) ABSTRACT

A method of generating electricity for mass production using the principles of gravity and buoyancy, that is:

Abundant, Environmentally friendly, Clean, Controlled and manageable, Geographically applicable, Cheap and Reliable.

### REFERENCES CITED

### U.S Patent Documents

| | | |
|---|---|---|
| 1,708,807 | April 1929 | F. Tatay |
| 2,037,973 | April 1936 | A. G. Grondahl |
| 2,135,110 | Nov. 1, 1938 | Platt |
| 3,857,242 | Dec. 31, 1974 | Gilmore |
| 3,934,964 | Jan. 27, 1976 | Diamond |
| 4,054,031 | Oct. 18, 1977 | Johnson |
| 4,498,294 | Feb. 12, 1985 | Everett |
| 4,538,415 | Sep. 3, 1985 | Lebecque |
| 4,715,182 | Dec. 29, 1987 | Adams |
| 5,753,978 | May 19, 1998 | Lee |
| 5,905,312 | May 18, 1999 | Liou |
| 5,944,480 | Aug. 31, 1999 | Forrest |
| 6,009,707 | Jan. 4, 2000 | Alkhamis |
| 6,249,057 B1 | Jun. 19, 2001 | Lehet |
| 6,305,165 B1 | Oct. 23, 2001 | Mizuki |
| 6,734,574 B2 | May 11, 2004 | Shin |
| 6,817,180 B2 | Nov. 16, 2004 | Newman |
| 6,978,610 B2 | Dec. 27, 2005 | Carnahan |
| 7,134,283 B2 | Nov. 14, 2006 | Villalobos |

### FIELD OF THE INVENTION

The present invention relates generally to an electricity generating apparatus and more specifically to a gravity-buoyancy energy system. The present invention utilizes principles of buoyancy to lift weights to selected height for subsequent use in gravitationally driving an energy generator.

### BACKGROUND OF THE INVENTION

With today's increased energy needs of society, generation of clean, sustainable and relatively cheap electricity with reduced geographic restrictions is essential.

Alternatives to conventional power generation sources such as nuclear power plants, use of coal/oil to generate electricity continue to be explored. However, the negative impact they have on the environment is enormous and therefore cleaner sources of energy are now proving to be of interest to society, governments and energy producing firms.

Clean and relatively cheap sources of energy such as Geothermal, Hydroelectricity, Solar energy, Tidal power, Wave Power and Wind Power plants are being used but they have a number of limitations such as destruction of the natural flow of rivers and their respective ecosystems, geographic limitations, dependence on factors that mankind has no control over such as clear skies, changes in the tides, high waves, windy days or constant rainy seasons to produce water which will in turn, run the Hydroelectricity plants.

Various devices and methods have been developed that use natural forces to generate electricity such as:

U.S. Pat. No. 7,134,283 to Victor Villalobos discloses a device for generating energy by the use of buoyancy and gravitational forces. A sealed-shaft, gravity-buoyancy energy system, where a wheel is powered by ball masses which fall due to gravity, thereby causing the wheel to rotate. The ball masses are collected and inserted into a fluid shaft, wherein the fluid shaft comprises at least two separate columns providing a negative force, and sealing of the fluid shaft so as to prevent fluid loss. Buoyant force raises the ball masses to the top of the device, wherein the ball masses are deposited once again onto the wheel. This system however exhibits difficulties, for the stated method of inserting the balls into the fluid will require an enormous amount of energy.

U.S. Pat. No. 5,944,480 to Forrest teaches a device for the generation of electricity by weights connected to each other by a chain. They are floated to the top and then dropped down due to the forces of gravity.

U.S. Pat. No. 6,249,057 to Lehet exhibits an energy conversion apparatus for converting compressed gas to shaft power.

U.S. Pat. No. 6,734,574 to Shin discloses a buoyancy-driven system for generating electric power utilizing Archimedes' Principle to drive magnet capsules through a fluid-filled portion of pipe and gravity to return the magnet capsules.

Due to the limitations of most power generation methods, it would ideally be desirable to develop alternative power generation methods that could provide a clean and sustainable source of abundant power on a constant basis at any given time with no geographic restrictions.

### SUMMARY OF THE INVENTION

The present invention relates to an electricity generating system that uses two free and abundant principles of nature; gravity and buoyancy to generate clean environmentally friendly energy on a large scale. The energy generated from this system would be;

Abundant—The two principles used in this system i.e. gravity and buoyancy are abundant and practically inexhaustible.
Environmentally friendly—
a) Clean—There are no emissions given of from this system and are practically 0 (zero). This there for meets the needs of today's clean energy goals.
b) Balance of eco-systems—No rivers have to be blocked to create dams nor do waters and the atmosphere have to be polluted with wastes from the production of energy using this system. This therefore put a cease to the destruction of some of the ecosystems such as aquatic, forest etc and biomes due to the production of energy.
Controlled and manageable—The amount of energy generated can be increased or decreased based on the size of the structure, where by a higher and larger structure would produce more energy than a shorter and smaller one.
Geographically applicable—The two principles that the system uses are found freely and in abundance all around the planet earth. This therefore implies that the system can be set up ideally anywhere.
Cheap—The system is based on two free principles of nature, therefore no cost have to be incurred in the purchase of raw material to produce energy.
Reliable—The amount of energy produced can be guaranteed for the two principles are in constant availability. There is no need to have constant sunny/windy days or a constant supply of combustible natural resources to produce energy. It can be produced at any given time and location.

An electricity generating system for driving one or more generators to produce clean eco-friendly energy, the electricity generating system comprising of:

A weight that is dropped from a given height through a chain system that traps and collects the energy given off from a body free falling due to the force of gravity then free-floated back to the top in a liquid due to forces of buoyancy and there after dropped back down thus causing a repeated system, so as to generate electricity. The use of both two free natural principles of nature (buoyancy and gravity) will hence create an abundant, reliable, ecological, environmentally friendly, universally and geographically applicable, cheap source of energy.

This system is based on two principles,
1. A weight “A” of mass “X” is dropped from a height “H”. The weight has enough mass whereby if dropped from a height “H”, generates enough force “F” to drive a pulley system which in turn spins the magnets in an electricity generator, hence producing electricity,
2. The density of the weight “A” is less than that of the liquid “L” which is used to float the weight “A” back to the top.

For example,

If the liquid “A” is water, a less dense weight is used such as wood coated with plastic or a light metal with a rubber tube around it filled with air.

This will solve today's energy problems such as;
a) Pollution due to the production of energy.
b) Environmental degradation due to the production of energy.
c) Destruction of the eco-systems due to the production of energy.
d) Dependence on non-renewable sources of energy.
e) Global warming due to the bi-products of energy production and consumption.
f) Land disputes that arise due to the construction of an energy production plant such as a Nuclear power plant or a Hydroelectricity plant.

The systems solves the above problems (a, b, c and e) in that the emissions produced during the production of electricity are practically close to zero (0)

The system uses two “clean” and “free” principles of nature that are practically inexhaustible. These being “gravity” and “buoyancy.” Hence as a result, solving the problem of dependence on non-renewable sources of energy and also problems (a, b, and c).

Since the system can be located anywhere, it will reduce on the burden that residents or ecosystems around energy production plants have to face, in that it can be located in a sparsely populated place/rural area. This will hence solve the problems of land disputes (as stated in f) due to the flexibility in the location of a power plant.

There currently exist a number of renewable sources of energy such as Biofuel, Biomass, Geothermal, Hydroelectricity, Solar energy, Tidal power, Wave Power and Wind Power to mention but a few.

However this system is advantageous over them in that;

It can be located anywhere for these two principles of nature are in occurrence all around the planet earth unlike the above which have to be located in a particular place such as along a river, in a region that receives a lot of sun light, a windy area or at sea in a place with ideal conditions such as strong waves or high tidal fluctuations.

This in principle will make it easy for mankind to harness energy for location will no longer be a problem.

### BRIEF DESCRIPTION OF THE DRAWINGS

The present invention can be more fully understood, by way of example, with reference to the following accompanying drawings, in which:

FIG. 1 is a front elevation of the electricity generating structure;

FIG. 2 is a right elevation of the electricity generating structure;

FIG. 3 is plan of the electricity generating structure;

FIG. 4 is an axonometric view of the electricity generating structure taken from A′;

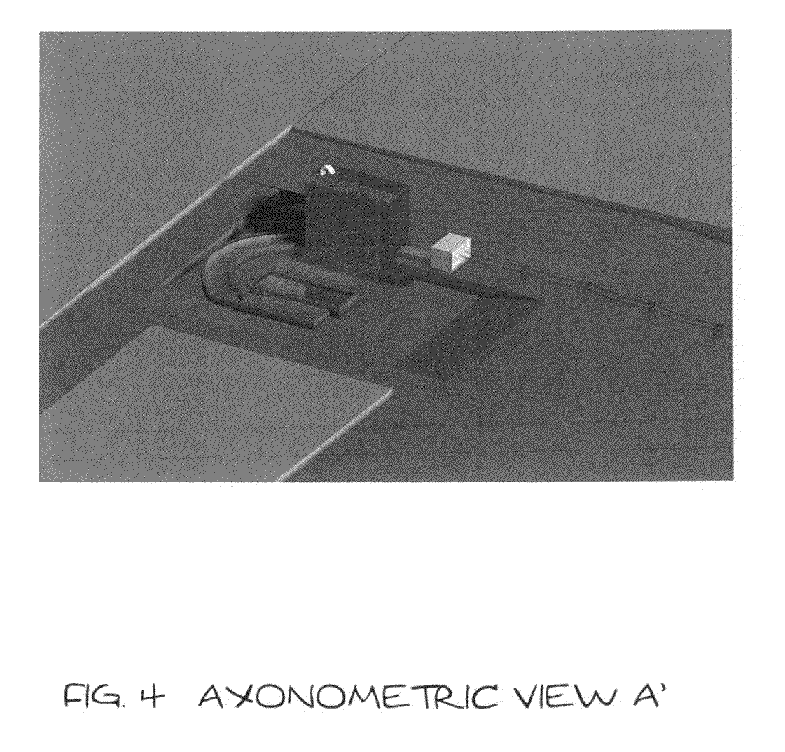

FIG. 5 an exploded axonometric view of FIG. 4;

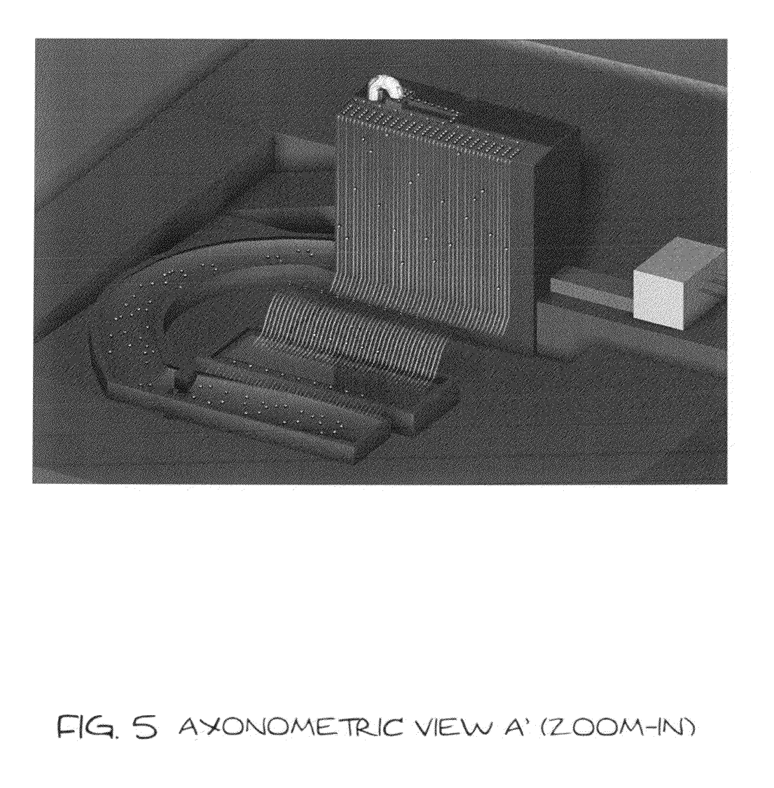

FIG. 6 is an axonometric view of the electricity generating structure taken from B′;

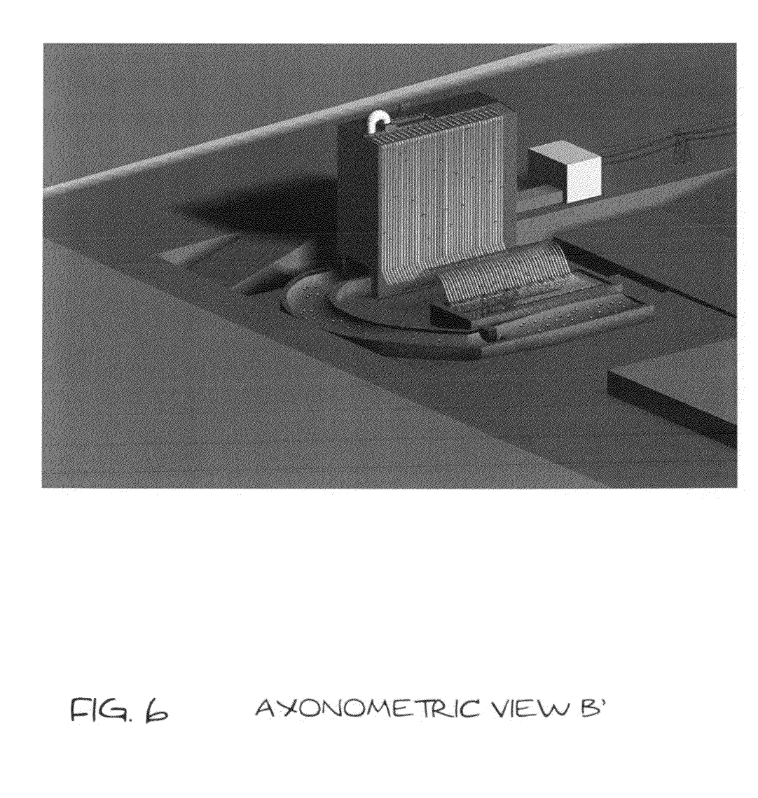

FIG. 7 is an exploded axonometric view of FIG. 6;

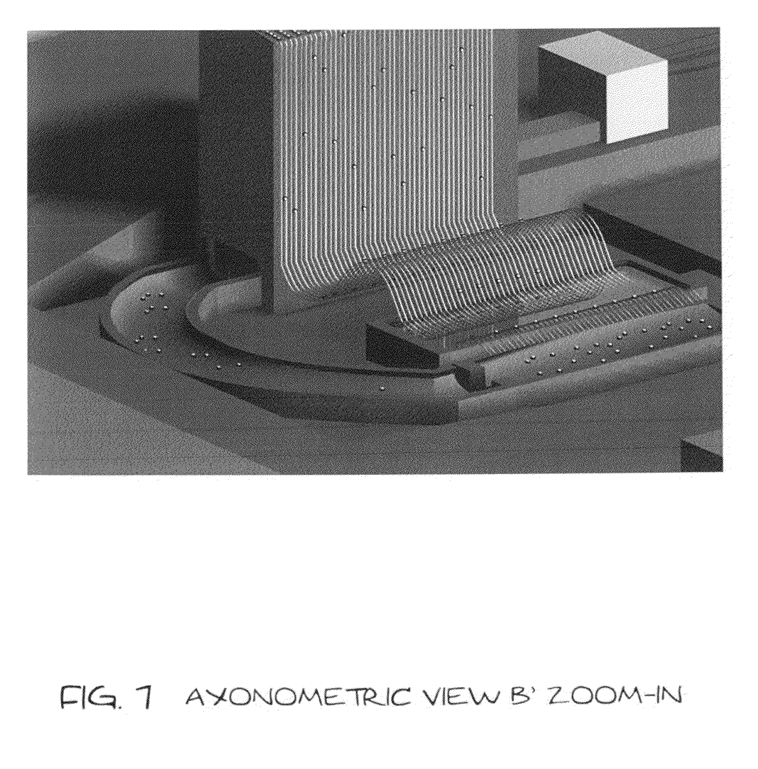

FIG. 8 is a clear through view of the structure showing the interior layout;

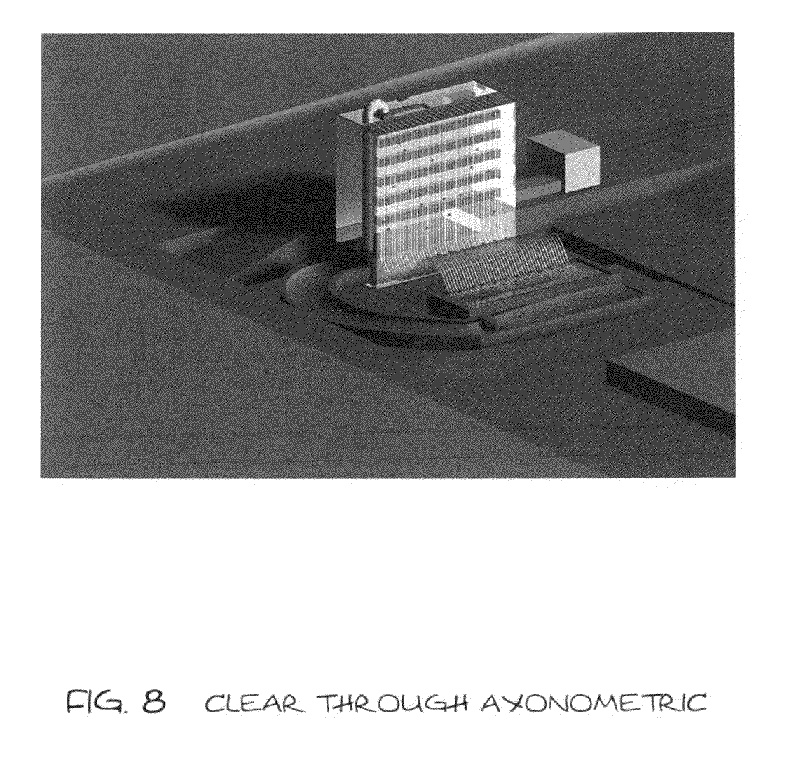

FIG. 9 is an exploded view of FIG. 8 showing the paths taken by the weights;

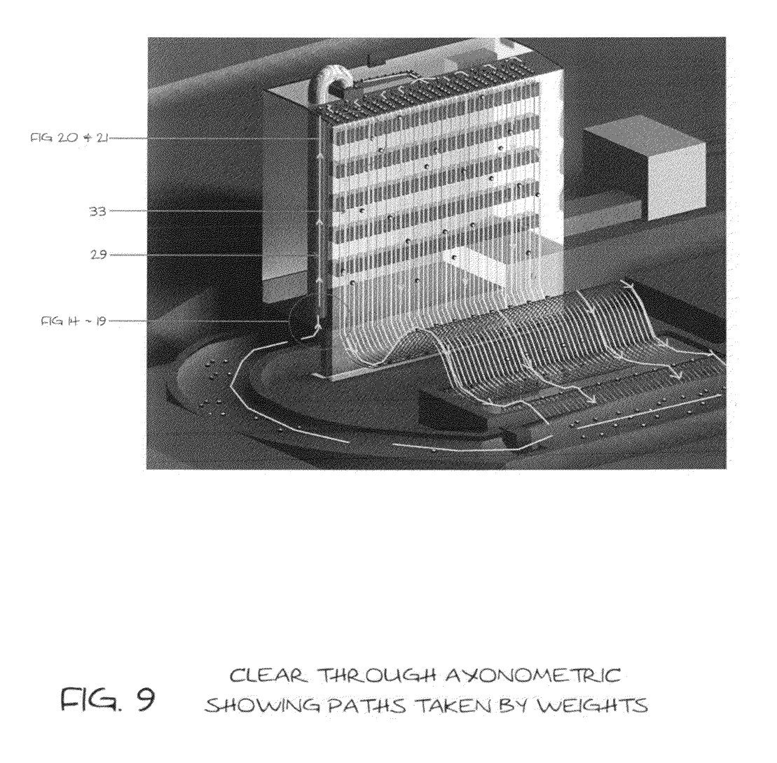

FIG. 10 is an axonometric view of a single weight;

FIG. 11 is another axonometric view of the weight in FIG. 10;

FIG. 12 is the bottom view of the weight in FIG. 10;

FIG. 13 is a cross section of the weight cut through the center, showing the interior structure;

FIG. 14 a schematic illustration of how the weight connect to the chain as it drops down;

FIG. 15 is a detailed schematic illustration taken from FIG. 9 showing the weights entering the unit (chamber #1);

FIG. 16 is a detailed schematic illustration showing the weights entering chamber #2 (27) and being stacked-up;

FIG. 17 is a schematic illustration showing water being pumped into chamber #2 (27) of FIG. 16;

FIG. 18 is a schematic illustration showing chamber #2 (27) of FIG. 16 opening and the weights starting to rise up (28);

FIG. 19 is a schematic illustration showing chamber #2 (27) of FIG. 16 closing on one side (30);

FIG. 20 is a schematic design showing water being pumped out (22) of chamber #2 (27) of FIG. 16;

FIG. 21 is a detailed schematic design taken from FIG. 9 showing how the force generated by the weights is transferred to the generator unit and

FIG. 22 is detailed schematic design showing multiple generators operating.

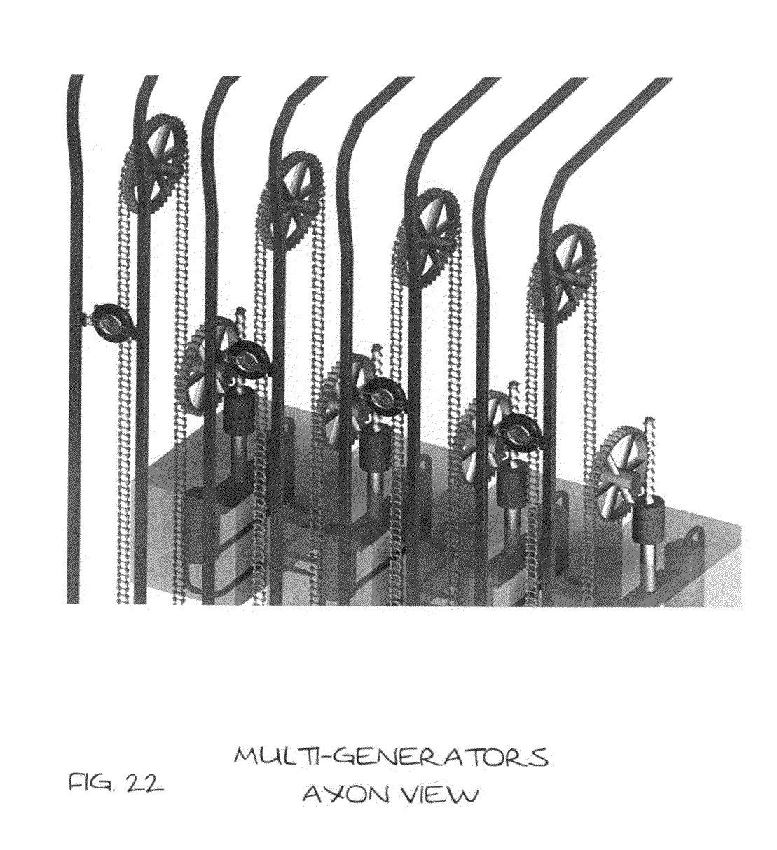

### DESCRIPTION OF RELATED ART

For generating electricity, a wheel is dropped from a given height and the energy produced is transferred to a chain system. A gear is attached at the back of the chain to transmit the vertical motion to a gear which in turn spins a permanent magnet centered in-between two coils to generate electricity.

The wheels drop to the bottom where they are collected and sent to a cylindrical chamber filled with a liquid that has a density greater that that of the wheels.

The wheels are inserted into the chamber from the bottom using a system of water tight and pressure tight seals located in a central chamber that opens to allow the wheels in on one side and opens on the other side to let the wheels out.

The said water and pressure tight doors (with ability to close and open) are located on either side of the chamber.

### DETAILED DESCRIPTION OF THE PREFERRED EMBODIMENTS

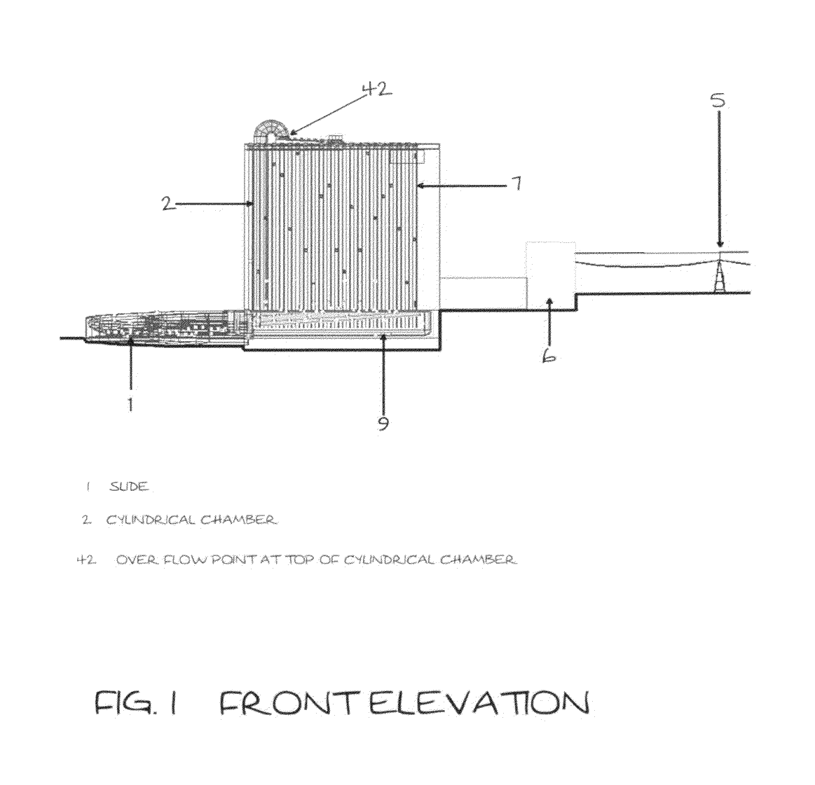

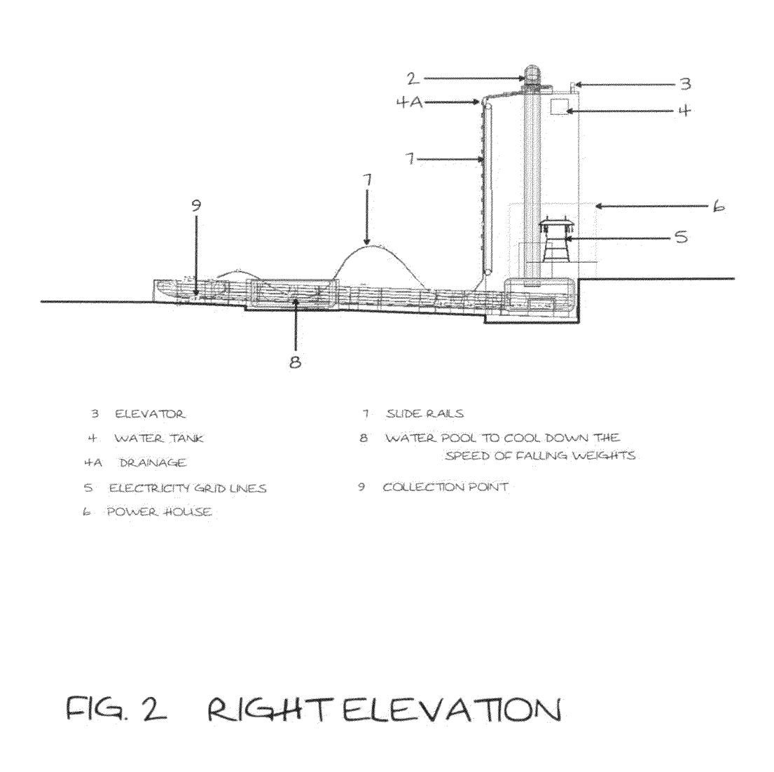

FIG. 1 shows the front elevation of the whole structure. 2 shows the cylindrical chamber which is filled with water. It is in this unit that the weights float to the top of the structure and are moved out by water overflowing from the top of the cylinder. The water is then drained at point 4A on FIG. 2 to a water tank 4 in FIG. 2. This water is pumped back to the top of the cylindrical chamber (2) to keep the water overflowing by a pump located near the water tank at 4 on FIG. 2.

The weights then slide down and are arranged and set at different drop off points at the edge of the structure, where they are let free to drop down due to the force of gravity.

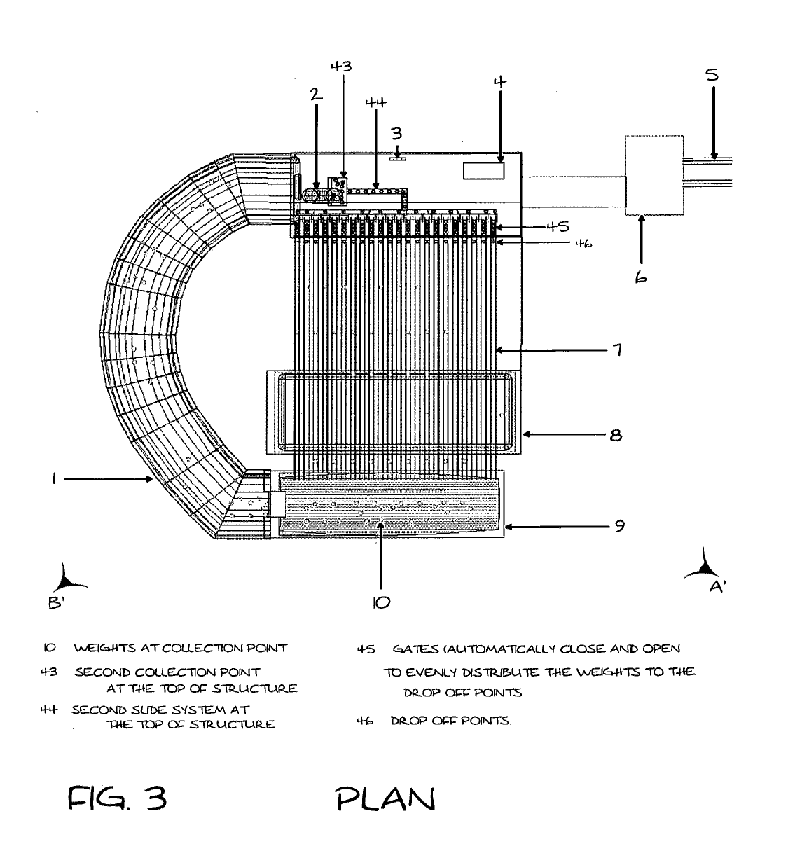

The weights drop down freely, but are guided in direction by slide rails as seen in 7 on FIG. 3.

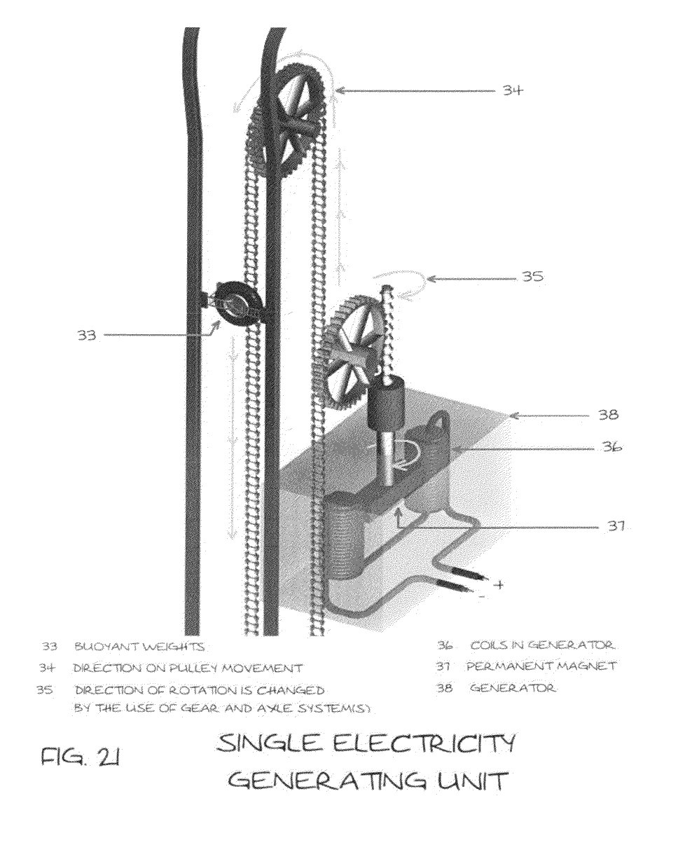

They then reach the bottom and the velocity is (optionally) cooled off by driving them up a height and into a water pool as seen at 8 or by trapping the motion using similar motors as shown in FIG. 21 but this time aligned at ground level.

There is a collection point where the weights all end up after the drop and then transferred back to the cylindrical chamber by a slide 1 FIG. 3.

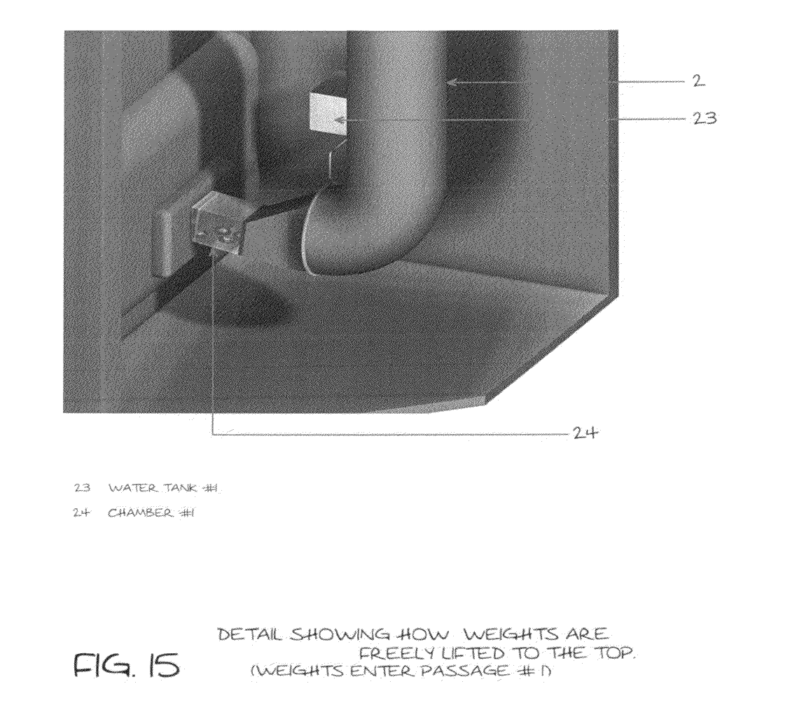

FIGS. 15 to 20 show a detailed schematic design of how the weights are inserted into the cylinder from the bottom.

In FIG. 15 the weights are seen entering the first chamber (24).

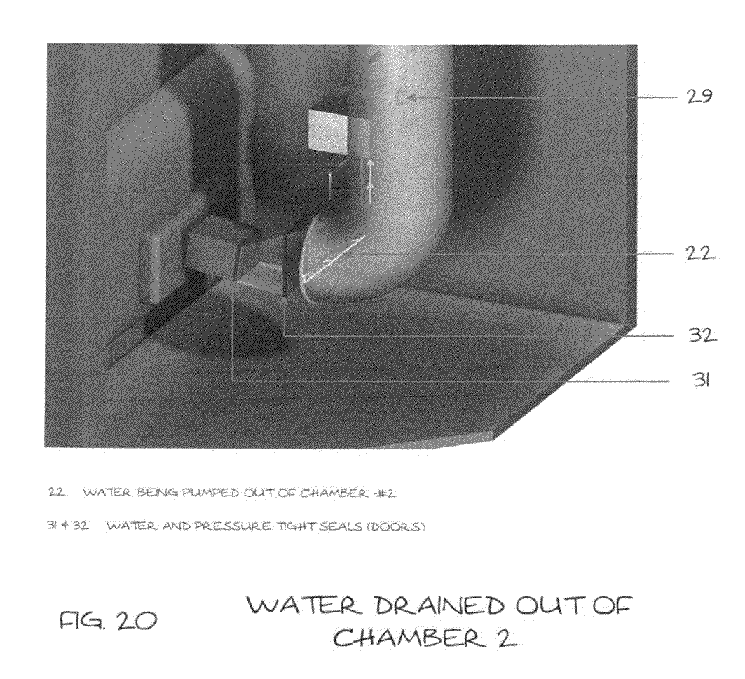

The water tight and pressure tight door (31 FIG. 20) between chamber #1 and chamber #2 then opens.

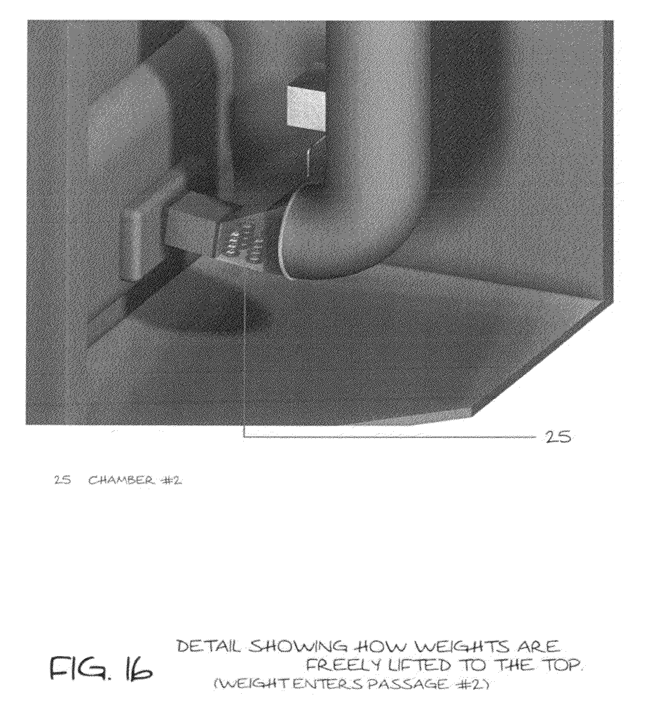

The weights are then moved into the second chamber (25 FIG. 16) where they are stacked-up in a way to fit as many as possible in the given space.

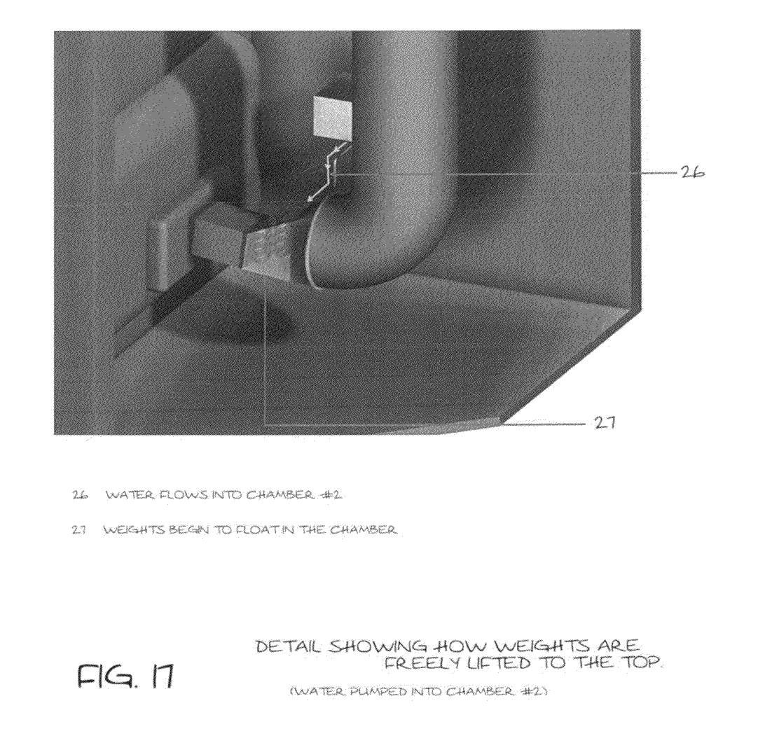

The water tight and pressure tight door (31 FIG. 20) between chamber #1 and chamber #2 then closes and water is pumped (26 FIG. 17) into the second chamber (chamber #2, 27 FIG. 17).

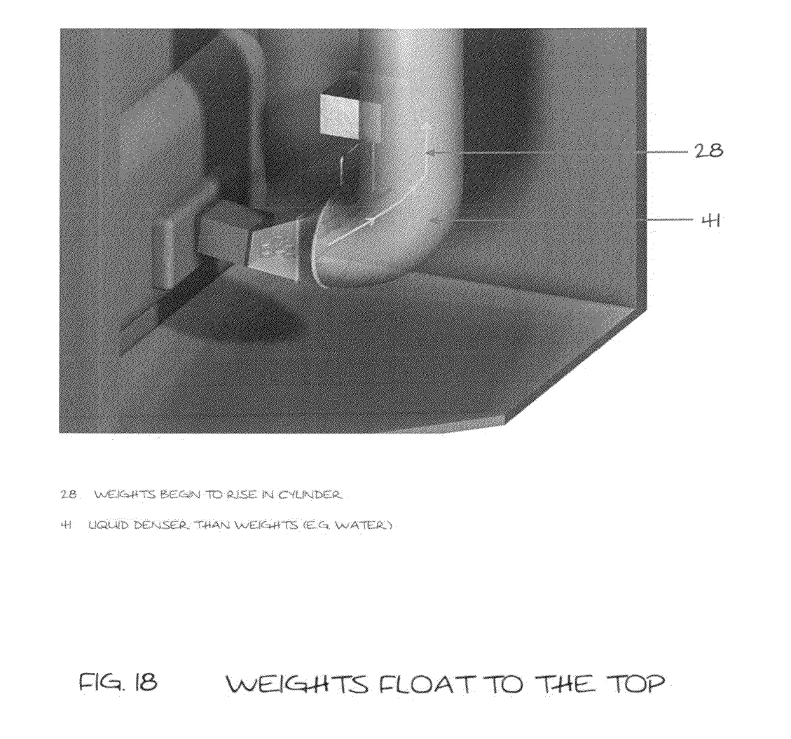

This will reduce the thrust caused when the next door (32) sealing off the cylindrical chamber and chamber #2 is opened (FIG. 18).

Once the second chamber is filled with water as seen in FIG. 17, the weights start to rise and float. The chamber is then sealed off (water and pressure tight) completely after which the door (32) between the second chamber and the cylindrical chamber is opened as seen in FIG. 18.

From this point, the weights start to rise up to the top of the cylinder (28 & 29) due to the forces of buoyancy since their density is less than that of water.

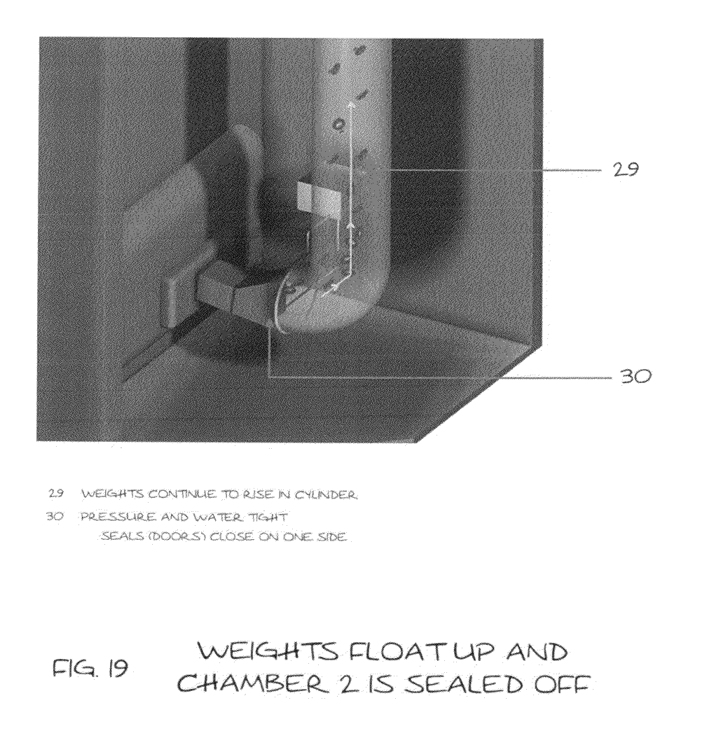

The door between the cylindrical chamber and that of the second chamber then closes and is sealed off (with a water and pressure tight seal) as seen in FIG. 19 The water in the second chamber is then drained out as seen in FIG. 20 and the doors (31) between it and the first chamber open to allow in more weights and the process is repeated.

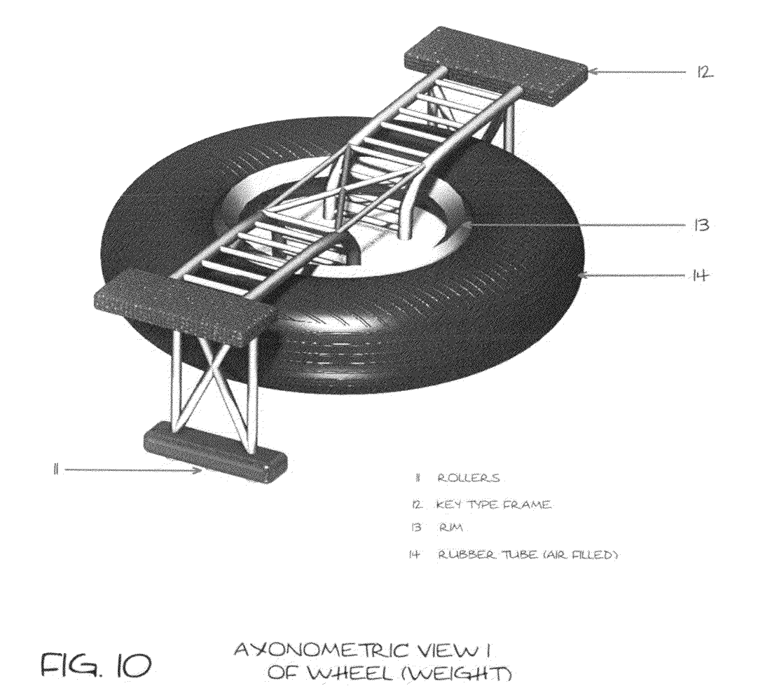

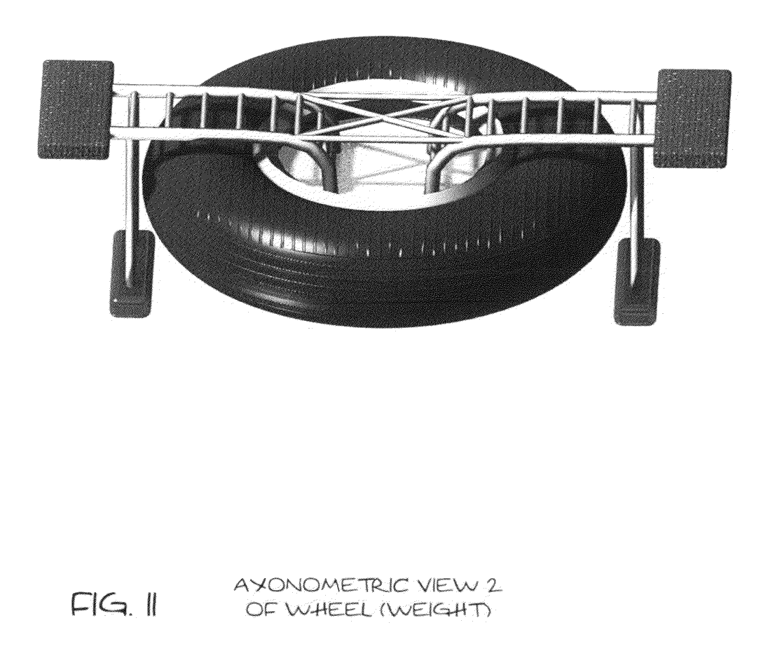

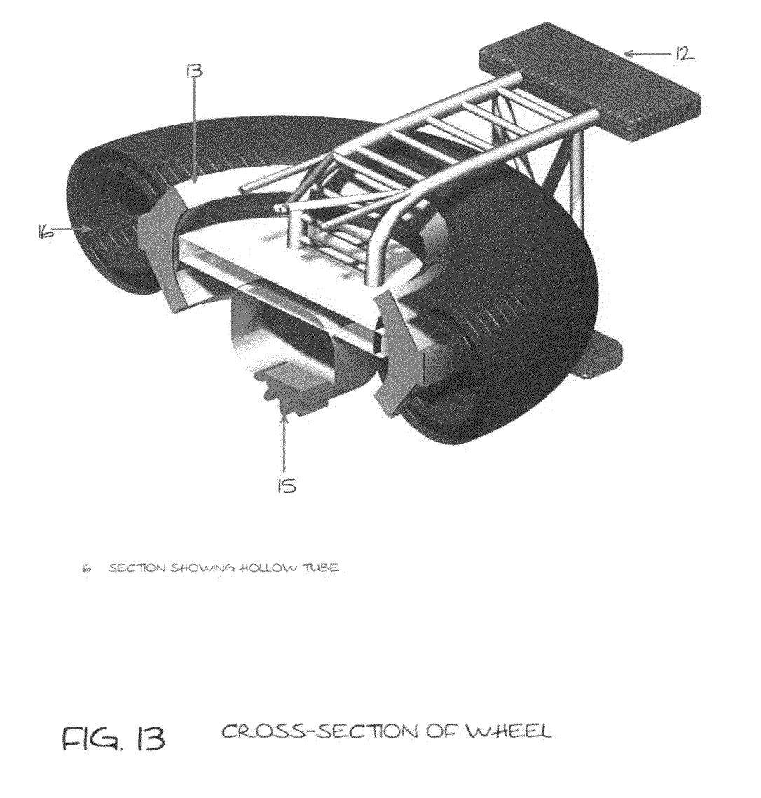

FIGS. 10 to 14 show a detailed schematic design of the wheel.

The wheel has two key type frames (12) that are used to guide the weight during free fall since they are aligned onto the socket of the slide rails 7 FIG. 2

The wheels have a buoyancy unit (14 FIG. 10) attached to them that is made out of a light and flexible material such as rubber which is then filled with air to keep them buoyant in water.

The rollers on the wheel (11 FIG. 10) are used to move it when on motion in an inclined plane i.e. 9 (collection point 9 FIG. 1) and slide 1 (FIG. 1).

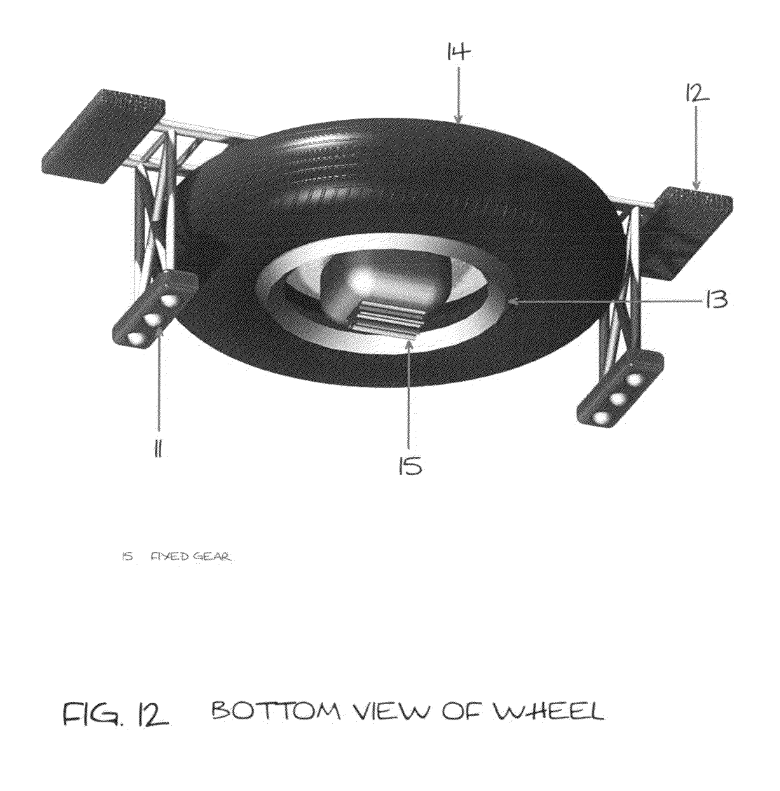

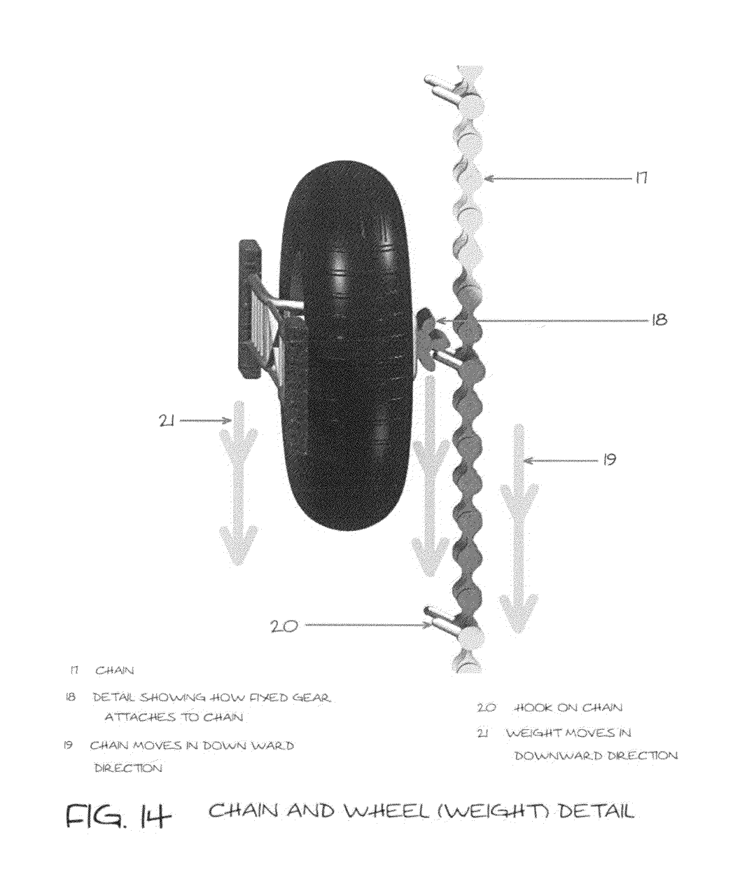

FIG. 12 shows the bottom view of the weight. 15 shows a fixed motionless gear that attaches itself to a chain when dropping as seen in FIG. 14. 20 are the clips used the hook onto the gear as the weight falls down.

This motion is then transferred to a pulley system (34 FIG. 21) by the chain (17 FIG. 14) which is then transferred to a generator unit comprising of a permanent magnet (37) that is spun around two coils (36) by a gear and axle system (35) hence producing electricity as seen in FIG. 21

It should be understood that the buoyant weights (33) are not necessarily in the shape portrayed in the drawings. They could be in any shape such as spherical, as long as they are heavy enough to drop a distance while pulling down a chain system and are buoyant in nature, in a stated fluid, such as water.

While the invention has been described with reference to preferred embodiments thereof, it is to be understood that modifications or variations may be easily made without departing from the spirit of this invention which is defined by the appended claims.

### LABELS RELATING TO CLAIMS

1—Slide
2—Transfer Point (Cylindrical Chamber)
7—Slide rails
9—Collection point
17—Chain
23—Water Tank #1
24—Chamber #1
25—Chamber #2
31/32—Water tight and Pressure tight seals
33—Body falling due to Gravity (buoyant weight that is dropped from a given height)
37—Permanent Magnet
38—Generator
41—Liquid denser that the weights (e.g. Water)
42—Overflow point at cylinder
43—Second collection point at the top of the structure
44—Second slide system at the top of the structure
45—Gates (Automatically close and open to evenly distribute the weights to the drop off points)
46—Drop off points

I claim:

1. An electricity generating system comprising of:
a series of generator units,
buoyant weights with a mass that can turn a pulley due to forces of gravity,
a fluid/liquid of greater density than the weights to transport them to the top of the electricity generating system,
a collection point,
a slide,
a set of chambers (chamber #1 and chamber #2),
a transfer point

2. The stated generator unit further comprising a permanent magnet that is spun from the force generated by a the stated buoyant weights falling freely due to gravity.

3. The stated electricity generating system further comprising of a system of guide rails with a chain centered in the middle of the said guide rails. The stated buoyant weight creates a force enough to spin permanent magnets in the generator units. The weight characterized by being buoyant in the sated liquid. (e.g. water)

4. The stated collection point in claim 1 being characterized by where the weights (wheels) end up after going through a drop.

5. The stated slide connected to the collection point so as to direct the wheels back to a transfer point consisting of a collection chamber (#1) and a second chamber (#2) where the weights are arranged awaiting to be lifted to the top.

6. The said chamber #2 consisting of two water tight and pressure tight seals on both sides which can slide open to let the weights into and out of the chamber.

7. The transfer point comprising of a water tank and pump used to pump water into said chamber #2 and then later drained back to the said water tank.

8. The stated transfer point (here from, referred to as cylindrical chamber) filled with a denser liquid in comparison to the weights, (here stated as water) where, the weights are floated to the top due to buoyancy. The cylindrical chamber is characterized by having an over flow of water at the top to keep the weights in motion out of the said cylindrical chamber. The stated overflow of water is created by a pump located at the top of the cylinder. The stated chamber also being able to drain the weights by gates at the top and an angled system of rails in the camber that are able to change the distance between them by either rotating 90 degrees or coming closer hense providing a tilt for the weights to flow out.

9. A second collection point at the top where the weights are dropped of after arising a given height from the said cylindrical chamber.

10. The stated second collection point in claim 9 comprising of slide system at the top of the structure that transfers the weights to the drop off point where they are dropped down a given height.

11. The stated collection point in claim 9 further comprising of gates that are automatically controlled to evenly distribute the weights to the drop off point.

12. A system of pulleys and gears to increase the R.P.M (Revolutions per Minute) and also transfer the motion to the stated generator.
